(19) United States
(12) Patent Application Publication
(10) Pub. No.: US 2023/0268484 A1
(43) Pub. Date: Aug. 24, 2023

(54) NEGATIVE ACTIVE MATERIAL FOR RECHARGEABLE LITHIUM BATTERY, NEGATIVE ELECTRODE INCLUDING SAME, AND RECHARGEABLE LITHIUM BATTERY INCLUDING SAME

(71) Applicant: SAMSUNG SDI CO., LTD., Yongin-si (KR)

(72) Inventors: Hee Seon CHOI, Yongin-si (KR); Soonbong CHOI, Yongin-si (KR); Joongho MOON, Yongin-si (KR); Ilyoung CHOI, Yongin-si (KR)

(21) Appl. No.: 17/965,085

(22) Filed: Oct. 13, 2022

(30) Foreign Application Priority Data
Feb. 22, 2022 (KR) 10-2022-0023252

(51) Int. Cl. H01M 4/36; H01M 4/583; H01M 10/052; H01M 4/04

(52) U.S. Cl. CPC H01M 4/364; H01M 4/583; H01M 10/052; H01M 4/0404; H01M 2004/021

(57) ABSTRACT

A negative active material for a rechargeable lithium battery, a negative electrode including the same, and a rechargeable lithium battery including the same, the negative active material including about 8 wt % to about 50 wt % of a first active material; and about 50 wt % to about 92 wt % of a second active material, all wt % being based on a total weight of the negative active material, wherein the first active material includes a rod-shaped crystalline carbon having a maximum length of about 75 μm to about 160 μm.

### CROSS-REFERENCE TO RELATED APPLICATION

This application claims priority to and the benefit of Korean Patent Application No. 10-2022-0023252 filed in the Korean Intellectual Property Office on Feb. 22, 2022, the entire contents of which are incorporated herein by reference.

### BACKGROUND

### 1. Field

Embodiments relate to a negative active material for a rechargeable lithium battery, a negative electrode including the same, and a rechargeable lithium battery including the same.

### 2. Description of the Related Art

Recently, with the rapid spread of electronic devices, using batteries, e.g., mobile phones, notebook computers, and electric vehicles, the demand for small, lightweight, and relatively high-capacity rechargeable batteries is rapidly increasing. A rechargeable lithium battery has recently drawn attention as a driving power source for portable devices, as it has lighter weight and high energy density. Accordingly, improving performances of rechargeable lithium batteries has been considered.

A rechargeable lithium battery includes a positive electrode and a negative electrode which includes an active material capable of intercalating and deintercalating lithium ions, and an electrolyte, and generates electrical energy due to the oxidation and reduction reaction when lithium ions are intercalated and deintercalated into the positive electrode and the negative electrode.

The above information disclosed in this Background section is only for enhancement of understanding of the background of the invention, and therefore it may contain information that does not form the prior art that is already known in this country to a person of ordinary skill in the art.

### SUMMARY

The embodiments may be realized by providing a negative active material for a rechargeable lithium battery, the negative active material including about 8 wt % to about 50 wt % of a first active material; and about 50 wt % to about 92 wt % of a second active material, all wt % being based on a total weight of the negative active material, wherein the first active material includes a rod-shaped crystalline carbon having a maximum length of about 75 μm to about 160 μm.

The rod-shaped crystalline carbon may have an aspect ratio of about 4 to about 30.

The rod-shaped crystalline carbon may include artificial graphite.

The second active material may include particle-shaped crystalline carbon, a rod-shaped crystalline carbon having a maximum length of less than about 75 μm, or a combination thereof.

The negative active material may include about 10 wt % to about 50 wt % of the first active material, and about 50 wt % to about 90 wt % of the second active material.

The embodiments may be realized by providing a negative electrode for rechargeable lithium battery, the negative electrode including a current collector; and a negative active material layer on the current collector, the negative active material layer including the negative active material according to an embodiment.

The first negative active material may be present on about 9 area % to about 45 area % per unit area of the negative active material layer.

The embodiments may be realized by providing a rechargeable lithium battery including the negative electrode according to an embodiment; a positive electrode; and an electrolyte.

### BRIEF DESCRIPTION OF THE DRAWINGS

Features will be apparent to those of skill in the art by describing in detail exemplary embodiments with reference to the attached drawings in which:

FIG. 1 is a schematic view showing the rod-shaped crystalline carbon according to one embodiment.

FIG. 2 is a schematic view showing the rechargeable lithium battery according to one embodiment.

FIG. 3 is a surface SEM image of the negative active material layer of the negative electrode according to Example 1.

FIG. 4 is a surface SEM image of the negative active material layer of the negative electrode according to Comparative Example 1.

### DETAILED DESCRIPTION

Example embodiments will now be described more fully hereinafter with reference to the accompanying drawing; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figure, the dimensions of layers and regions may be exaggerated for clarity of illustration. It will also be understood that when a layer or element is referred to as being “on” another layer or element, it can be directly on the other layer or element, or intervening layers may also be present. In addition, it will also be understood that when a layer is referred to as being “between” two layers, it can be the only layer between the two layers, or one or more intervening layers may also be present. Like reference numerals refer to like elements throughout. As used herein, the term “or” is not an exclusive term, e.g., “A or B” would include A, B, or A and B.

In the specification, when a definition is not otherwise provided, an average particle diameter indicates an average particle diameter (D50) where a cumulative volume is about 50 volume % in a particle distribution. The average particle size (D50) may be measured by a method well known to those skilled in the art, for example, by a particle size analyzer, or by a transmission electron microscopic image or a scanning electron microscopic image. Alternatively, a dynamic light-scattering measurement device is used to perform a data analysis, and the number of particles is counted for each particle size range. From this, the average particle diameter (D50) value may be easily obtained through a calculation.

A negative active material for a rechargeable lithium battery according to one embodiment may include, e.g., about 8 wt % to about 50 wt % of a first active material and about 50 wt % to about 92 wt % of a second active material (e.g., based on a total weight of the negative active material). In an implementation, the first active material may include a rod-type crystalline carbon having a long diameter (e.g., dimension or length of a major axis) of, e.g., about 75 μm to about 160 μm.

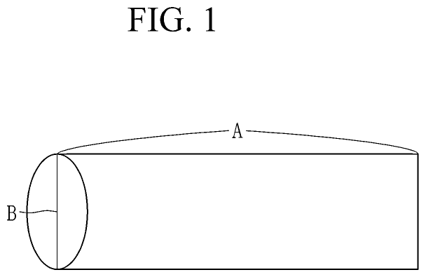

The long diameter means a length, e.g., a size or length of a long axis (A) among the long axis (A) and a short axis (B) of the rod (stick) crystalline carbon shown in FIG. 1. In an implementation, the long diameter may be a maximum long diameter.

When the long rod-shaped crystalline carbon with a length of about 75 μm to about 160 μm (hereinafter, referred as “long rod-shaped crystalline carbon”) is used as a negative active material, e.g., at an amount of about 8 wt % to about 50 wt % based on the total weight (e.g.,100 wt %) of the negative active material, the high-rate charge and discharge characteristics may be improved, or the electrical conductivity may be improved. The long rod-shaped crystalline carbon having a length of about 75 μm to about 160 μm may help decrease the denseness or density of the negative active material layer to help prevent volume expansion, which could otherwise occur during the charge and the discharge, and may act as a lithium ion passage to facilitate a reduction in resistance.

In an implementation, the long rod-shaped crystalline carbon may have a length of, e.g., about 75 μm to about 160 μm, about 80 μm to about 130 μm, or about 80 μm to about 120 μm. If the length of the long rod-shaped crystalline carbon were to be less than 75 μm, the resistance and the expansion could be increased, or the power characteristic could be deteriorated. If the length were to be more than 160 μm, the size thereof could be too large, especially, larger than a thickness of the negative electrode, causing problems for production.

The long rod-shaped crystalline carbon may have an aspect ratio of, e.g., about 4 to about 30, or about 4 to about 20. In an implementation, the aspect ratio may be an average aspect ratio. When the aspect ratio of the long rod-shaped crystalline carbon is within the ranges, the resistance may be reduced, the expansion may be suppressed, and the power characteristic may be improved.

The amount of the first negative active material, which is the long rod-shaped crystalline carbon, may be, e.g., about 8 wt % to about 50 wt %, based on the total weight of the negative active material, about 10 wt % to about 50 wt %, or about 20 wt % to about 50 wt %. When the amount of the first negative active material which is the long rod-shaped crystalline carbon is satisfied within the ranges, the desired effect such as improvements in the high-rate characteristic and electrical conductivity characteristics may be obtained. If the amount were to be outside of the ranges, e.g., if the first negative active material were to be included in a relatively small amount, the improvement effects may not be satisfied, and if the amount were to be larger than the ranges, the capacity could be deteriorated.

In contrast to the effects of using or including the long rod-shaped crystalline carbon at about 10 wt % to about 30 wt %, using fiber-shaped carbon nanotubes or nanocarbon fiber may not satisfy battery performances and the characteristics required in design, due to the larger specific surface area, even if a length there of were to be sufficiently long.

The rod-shape indicates a stick-shape substantially filled inside, and the fiber-shape indicates a shape having a hollow and not filled inside.

The long rod-shaped crystalline carbon may be, e.g., artificial graphite.

In an implementation, the second active material may be, e.g., particle-shaped crystalline carbon, a rod-shaped crystalline carbon having a maximum long diameter of less than about 75 μm, or a combination thereof.

The particle-shaped crystalline carbon may have an average particle diameter D50 of, e.g., about 10 μm to about 25 μm, or about 15 μm to about 25 μm.

The rod-shaped crystalline carbon having a maximum long diameter of less than 75 μm, e.g., the short rod-shaped crystalline carbon, may have a long diameter, e.g., a length, of less than 75 μm, and it may be necessary to limit a minimum value. In an implementation, it may be a rod-shaped crystalline carbon having of long diameter of less than 75 μm and 20 μm or more.

A negative electrode according to one embodiment may include a current collector and a negative active material layer on at least one surface of the current collector.

In an implementation, the negative active material layer may include the negative active material, e.g., the first active material and the second active material. In an implementation, in the negative active material, the first active material may be present at or on (e.g., covers) about 9 area % to about 45 area %, or about 10 area % to about 27 area %, per unit area of the negative active material layer. When the first active material is present at the area %, the improvements in the resistance and the power may be obtained.

In the negative active material layer, the area % in which the first active material is present may be measured from particle analysis of component constituents after capturing an image of 2D particles from an image of 3D particles using a particle analyzer (available from Malvern Panalytical, Ltd).

In the negative active material, an amount of the negative active material may be about 95 wt % to about 98 wt %, based on the total weight of the negative active material layer.

In an implementation, the negative active material layer may include a binder, and may further include a conductive material. An amount of the binder may be, e.g., about 1 wt % to about 5 wt %, based on the total weight of the negative active material layer. An amount of the conductive material may be, e.g., about 1 wt % to about 5 wt %, based on the total weight of the negative active material layer.

The binder may help improve binding properties of negative active material particles with one another and with a current collector. The binder may be a non-aqueous binder, an aqueous binder, or a combination thereof.

The non-aqueous binder may include, e.g., an ethylene propylene copolymer, polyacrylonitrile, polystyrene, polyvinylchloride, carboxylated polyvinylchloride, polyvinylfluoride, polyurethane, polytetrafluoro ethylene, polyvinylidene fluoride, polyethylene, polypropylene, polyamide imide, polyimide, or a combination thereof.

The aqueous binder may include, e.g., a styrene-butadiene rubber (SBR), an acrylated styrene-butadiene rubber (ABR), an acrylonitrile-butadiene rubber, an acrylic rubber, a butyl rubber, a fluorine rubber, an ethylene oxide-containing polymer, polyvinyl pyrrolidone, polyepichlorohydrin, polyphosphazene, an ethylene propylene diene copolymer, polyvinylpyridine, chlorosulfonated polyethylene, latex, polyester resin, an acrylic resin, a phenolic resin, an epoxy resin, polyvinyl alcohol, or a combination thereof.

When the aqueous binder is used as a negative electrode binder, a cellulose compound may be further included to provide viscosity as a thickener. The cellulose compound may include, e.g., carboxymethyl cellulose, hydroxypropylmethyl cellulose, methyl cellulose, or alkali metal salts thereof. The alkali metal may include Na, K, or Li. The thickener may be included in an amount of, e.g., about 0.1 parts by weight to about 3 parts by weight, based on 100 parts by weight of the negative active material.

The conductive material may be included to provide electrode conductivity, and a suitable electrically conductive material that does not cause a chemical change may be used. Examples of the conductive material may include a carbon material such as natural graphite, artificial graphite, carbon black, acetylene black, ketjen black, a carbon fiber, and the like; a metal material of a metal powder or a metal fiber including copper, nickel, aluminum, silver, and the like; a conductive polymer such as a polyphenylene derivative; or a mixture thereof.

In an implementation, the current collector may include, e.g., a copper foil, a nickel foil, a stainless steel foil, a titanium foil, a nickel foam, a copper foam, a polymer substrate coated with a conductive metal, or a combination thereof.

Another embodiment provides a negative electrode, a positive electrode, and an electrolyte.

The positive electrode may include a current collector and a positive active material layer formed on the current collector.

The positive electrode active material may include lithiated intercalation compounds that reversibly intercalate and deintercalate lithium ions (lithiated intercalation compound). In an implementation, one or more composite oxides of a metal selected from cobalt, manganese, nickel, and a combination thereof, and lithium may be used. In an implementation, the compounds represented by one of the following chemical formulae may be used. LiₐA_{1-b}X_{b}D¹₂ (0.90≤a≤1.8, 0≤b≤0.5); LiₐA_{1-b}X_{b}O_{2-c1}D_{c1}(0.90≤a≤1.8, 0≤b≤0.5, 0≤c1≤0.05); LiₐE_{1-b}X_{b}O_{2-c1}D¹_{c1} (0.90≤a≤1.8, 0≤b≤0.5, 0≤c1≤0.05); LiₐE_{2-b}X_{b}O_{4-c1}D¹_{c1} (0.90≤a≤1.8, 0≤b≤0.5, 0≤c1≤0.05); LiₐNi_{1-b-c}Co_{b}X_{c}D¹_{α}(0.90≤a≤1.8, 0≤b≤0.5, 0≤c≤0.5, 0≤a≤2); LiₐNi_{1-b-c}Co_{b}X_{c}O_{2-α}T_{α}(0.90≤a≤1.8, 0≤b≤0.5, 0≤c≤0.5, 0≤a≤2); LiₐNi_{1-b-c}Co_{b}X_{c}O_{2-α}T₂ (0.90≤a≤1.8, 0≤b≤0.5, 0≤c≤0.5, 0≤α≤2); LiₐNi_{1-b-c}Mn_{b}X_{c}D^{l}_{α}(0.90≤a≤1.8, 0≤b≤0.5, 0 ≤c≤0.5, 0≤α≤2); LiₐNi_{1-b-c}Mn_{b}X_{c}O_{2-α}T_{α}(0.90≤a≤1.8, 0≤b≤0.5, 0≤c≤0.5, 0≤α≤2); LiₐNi_{1-b-c}Mn_{b}X_{c}O_{2-α}T₂ (0.90≤a≤1.8, 0≤b≤0.5, 0≤c≤0.5, 0≤α≤2); LiₐNi_{b}E_{c}G_{d}O₂ (0.90≤a≤1.8,0 b≤0.9, 0≤c≤0.5, 0.001≤d≤0.1); LiₐNi_{b}Co_{c}Mn_{d}GₑO₂ (0.90≤a≤1.8.0≤b≤0.9.0≤c≤0.5,0≤d≤0.5, 0.001≤e≤0.1); LiₐNiG_{b}O₂ (0.90≤a≤1.8, 0.001≤b≤0.1) LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂(PO₄)₃(0≤f≤2); Li₍₃₋₄₎Fe₂(PO₄)₃(0≤f≤2); LiₐFePO₄ (0.90≤a≤1.8)

In the above chemical formulae, A may be selected from Ni, Co, Mn, and a combination thereof; X may be selected from Al, Ni, Co, Mn, Cr, Fe, Mg, Sr, V, a rare earth element, and a combination thereof; D may be selected from O, F, S, P, and a combination thereof, E may be selected from Co, Mn, and a combination thereof, T may be selected from F, S, P, and a combination thereof; G may be selected from Al, Cr, Mn, Fe, Mg, La, Ce, Sr, V, and a combination thereof, Q may be selected from Ti, Mo, Mn, and a combination thereof, Z may be selected from Cr, V, Fe, Sc, Y, and a combination thereof, and J may be selected from V, Cr, Mn, Co, Ni, Cu, and a combination thereof.

In an implementation, the compounds may have a coating layer on the surface, or may be mixed with another compound having a coating layer. The coating layer may include a coating element compound, e.g., an oxide of a coating element, a hydroxide of a coating element, an oxyhydroxide of a coating element, an oxycarbonate of a coating element, or a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed in a method having no adverse influence on properties of a positive electrode active material by using these elements in the compound, e.g., the method may include any coating method such as spray coating, dipping, or the like.

In the positive electrode, an amount of the positive active material may be about 90 wt % to about 98 wt %, based on the total weight of the positive active material layer.

In an implementation, the positive active material layer may further include a binder and a conductive material. In an implementation, the binder and the conductive material may be included in an amount of about 1 wt % to about 5 wt %, respectively, based on the total amount of the positive active material layer.

The binder may help improve binding properties of positive electrode active material particles with one another and with a current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, styrene butadiene rubber, acrylated styrene butadiene rubber, an epoxy resin, nylon, and the like.

The conductive material may be included to provide electrode conductivity, and a suitable electrically conductive material that does not cause a chemical change may be used. Examples of the conductive material may include a carbon material such as natural graphite, artificial graphite, carbon black, acetylene black, ketjen black, a carbon fiber, and the like; a metal material of a metal powder or a metal fiber including copper, nickel, aluminum, silver, and the like; a conductive polymer such as a polyphenylene derivative; or a mixture thereof.

The current collector may include, e.g., aluminum foil, nickel foil, or a combination thereof.

The electrolyte may include a non-aqueous organic solvent and a lithium salt.

The non-aqueous organic solvent may serve as a medium for transmitting ions taking part in the electrochemical reaction of a battery.

The non-aqueous organic solvent may include a carbonate, ester, ether, ketone, alcohol, or aprotic solvent.

The carbonate solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or the like. The ester solvent may include methyl acetate, ethyl acetate, n-propyl acetate, dimethyl acetate, methyl propionate, ethyl propionate, propyl propionate decanolide, mevalonolactone, caprolactone, or the like. The ether solvent may include dibutyl ether, tetraglyme, diglyme, dimethoxyethane, 2-methyltetrahydrofuran, tetrahydrofuran, or the like. The ketone solvent may include cyclohexanone or the like. The alcohol solvent may include ethyl alcohol, isopropyl alcohol, or the like. The aprotic solvent include nitriles such as R-CN (where R is a C2 to C20 linear, branched, or cyclic hydrocarbon, and may include a double bond, an aromatic ring, or an ether bond), amides such as dimethylformamide, dioxolanes such as 1,3-dioxolane, sulfolanes, or the like.

The organic solvent may be used alone or in a mixture. When the organic solvent is used in a mixture, the mixture ratio may be controlled in accordance with a desirable battery performance.

In an implementation, the carbonate solvent may include a mixture with a cyclic carbonate and a linear carbonate. The cyclic carbonate and the linear carbonate may be mixed together in a volume ratio of about 1:1 to about 1:9, and when the mixture is used as an electrolyte, it may have enhanced performance.

The organic solvent may further include an aromatic hydrocarbon solvent as well as the carbonate solvent. The carbonate solvent and the aromatic hydrocarbon solvent may be mixed together in a volume ratio of about 1:1 to about 30:1.

The aromatic hydrocarbon organic solvent may include an aromatic hydrocarbon compound represented by Chemical Formula 1.

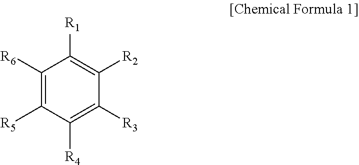

In Chemical Formula 1, R₁ to R₆ μmay each independently be or include, e.g., hydrogen, a halogen, a C1 to C10 alkyl group, a haloalkyl group, and a combination thereof.

Examples of the aromatic hydrocarbon organic solvent may include benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, or a combination thereof.

The electrolyte may further include vinyl ethyl carbonate, vinylene carbonate, or an ethylene carbonate compound represented by Chemical Formula 2 as an additive for improving cycle life.

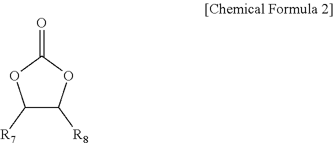

In Chemical Formula 2, R₇ and R₈ μmay each independently be or include, e.g., hydrogen, a halogen, a cyano group (CN), a nitro group (NO₂), or a C1 to C5 fluoroalkyl group. In an implementation, at least one of R₇ and R₈ μmay be a halogen, a cyano group (CN), a nitro group (NO₂), or a C1 to C5 fluoroalkyl group, and R₇ and R₈ are not simultaneously hydrogen.

Examples of the ethylene carbonate compound may include difluoro ethylene carbonate, chloroethylene carbonate, dichloroethylene carbonate, bromoethylene carbonate, dibromoethylene carbonate, nitroethylene carbonate, cyanoethylene carbonate, or fluoroethylene carbonate. An amount of the additive for improving the cycle-life characteristics may be used within an appropriate range.

The lithium salt dissolved in an organic solvent may supply a battery with lithium ions, basically operates the rechargeable lithium battery, and may help improve transportation of the lithium ions between a positive electrode and a negative electrode. Examples of the lithium salt may include at least one or two supporting salt selected from LiPF₆, LiBF₄, LiSbF₆, LiAsF₆, LiN(SO₂C₂F₅)₂, Li(CF₃SO₂)₂N, LiN(SO₃C₂F₅)₂, LiF(SO₂)₂N (lithium bis(fluorosulfonyl)imide: LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂), wherein x and y are natural numbers, e.g., an integer of 1 to 20, lithium difluoro(bisoxolato) phosphate), LiCl, LiI, LiB(C₂O₄)₂ (lithium bis(oxalato) borate: LiBOB) and lithium difluoro(oxalato)borate (LiDFOB). A concentration of the lithium salt may range from about 0.1 M to about 2.0 M. When the lithium salt is included at the above concentration range, an electrolyte may have excellent performance and lithium ion mobility due to optimal electrolyte conductivity and viscosity.

A separator may be between the positive electrode and the negative electrode depending on a type of a rechargeable lithium battery. The separator may include polyethylene, polypropylene, polyvinylidene fluoride or multi-layers thereof having two or more layers and may be a mixed multilayer such as a polyethylene/polypropylene double-layered separator, or a polyethylene/polypropylene/polyethylene triple-layered separator.

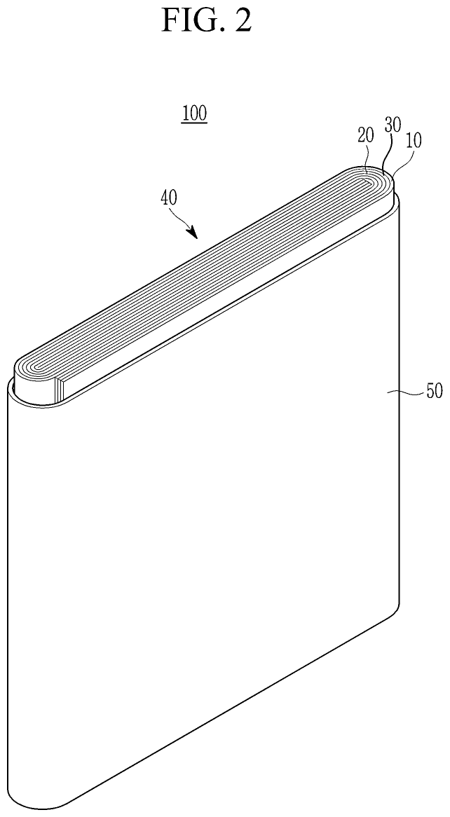

FIG. 2 is an exploded perspective view of a rechargeable lithium battery according to an embodiment. As illustrated in FIG. 2, the rechargeable lithium battery according to an embodiment may be a prismatic battery, may include variously-shaped batteries such as a cylindrical battery, a pouch battery, or the like.

Referring to FIG. 2, a rechargeable lithium battery 100 according to an embodiment may include an electrode assembly 40 μmanufactured by winding a separator 30 between a positive electrode 10 and a negative electrode 20 and a case 50 housing the electrode assembly 40. An electrolyte may be impregnated in the positive electrode 10, the negative electrode 20, and the separator 30.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

A mixed negative active material of a long rod-shaped artificial graphite having a maximum long diameter (length) of 80 μm and an average aspect ratio of 5 to 10 as a first active material, a particle-shaped artificial graphite having an average particle diameter D50 of 15 μm as a second active material (a weight ratio of the first active material: the second active material=30:70), styrene butadiene rubber as a binder and carboxymethyl cellulose as an agent for increasing viscosity were mixed in water in a weight ratio of 96:3:1 to prepare a negative active material slurry.

The negative active material slurry was coated on a Cu foil current collector, dried, and compressed by the general procedure to prepare a negative electrode including a current collector and a negative active material layer formed on the current collector.

Using the negative electrode, a lithium metal counter electrode, and an electrolyte, a rechargeable lithium cell was fabricated. The electrolyte was a 1.5M LiPF₆ solution in a mixed solvent of ethylene carbonate, ethyl methyl carbonate, and dimethyl carbonate (20:10:70 volume ratio).

### Example 2

A negative electrode and a coin-type half-cell were prepared by the same procedure as in Example 1, except that a long rod-type artificial graphite having a maximum long diameter (length) of 100 μm and an average aspect ratio of 5 to 10 was used as a first active material.

### Example 3

A negative electrode and a coin-type half-cell were prepared by the same procedure as in Example 1, except that a long rod-type artificial graphite having a maximum long diameter (length) of 120 μm and an aspect ratio of 5 to 10 was used as a first active material, and short rod-shaped artificial graphite having a long diameter (length) of 30 μm and an aspect ratio of 4 to 20 was used as a second active material.

### Example 4

A negative electrode and a coin-type half-cell were prepared by the same procedure as in Example 1, except that a short rod-shaped artificial graphite having a long diameter (length) of 20 μm and an aspect ratio of 5 to 10 as a second active material, was used, instead of using the particle-shaped artificial graphite having an average particle diameter (D50) of 15 μm.

### Comparative Example 1

A mixed negative active material of a particle-shaped artificial graphite having an average particle diameter (D50) of 18 μm as a first active material, a particle-shaped artificial graphite having an average particle diameter D50 of 15 μm as a second active material (a weight ratio of the first active material:the second active material=30:70), styrene butadiene rubber as a binder and carboxymethyl cellulose as an agent for increasing viscosity were mixed in water in a weight ratio of 96:3:1 to prepare a negative active material slurry.

Using the negative active material slurry, a negative electrode and a half-cell were prepared by the same procedure as in Example 1.

### Comparative Example 2

A mixed negative active material of a long rod-shaped artificial graphite having a maximum long diameter (length) of 70 μm and an average aspect ratio of 5 to 10 as a first active material, a particle-shaped artificial graphite having an average particle diameter D50 of 15 μm as a second active material (a weight ratio of the first active material:the second active material=30:70), styrene butadiene rubber as a binder, and carboxymethyl cellulose as an agent for increasing viscosity were mixed in water in a weight ratio of 96:3:1 to prepare a negative active material slurry.

Using the negative active material slurry, a negative electrode and a half-cell were prepared by the same procedure as in Example 1.

### Comparative Example 3

A mixed negative active material of carbon nanotube having a maximum long diameter (length) of 80 μm and an average aspect ratio of 5 to 10 as a first active material, a particle-shaped artificial graphite having an average particle diameter D50 of m as a second active material (a weight ratio of the first active material:the second active material=30:70), styrene butadiene rubber as a binder, and carboxymethyl cellulose as an agent for increasing viscosity were mixed in water in a weight ratio of 96:3:1 to prepare a negative active material slurry.

Using the negative active material slurry, a negative electrode and a half-cell were prepared by the same procedure as in Example 1.

### Comparative Example 4

A mixed negative active material of carbon nanofiber having a maximum long diameter (length) of 80 μm and an average aspect ratio of 5 to 10 as a first active material, a particle-shaped artificial graphite having an average particle diameter D50 of m as a second active material (a weight ratio of the first active material:the second active material=30:70), styrene butadiene rubber as a binder and carboxymethyl cellulose as an agent for increasing viscosity were mixed in water in a weight ratio of 96: 3: 1 to prepare a negative active material slurry.

Using the negative active material slurry, a negative electrode and a half-cell were prepared by the same procedure as in Example 1.

### Comparative Example 5

A mixed negative active material of a long rod-shaped artificial graphite having a maximum long diameter (length) of 70 μm and an average aspect ratio of 5 to 10 as a first active material, a rod-shaped artificial graphite having a long diameter (length) of m and an average aspect ratio of 2 to 10 as a second active material (a weight ratio of the first active material:the second active material=30:70), styrene butadiene rubber as a binder, and carboxymethyl cellulose as an agent for increasing viscosity were mixed in water in a weight ratio of 96:3:1 to prepare a negative active material slurry.

Using the negative active material slurry, a negative electrode and a half-cell were prepared by the same procedure as in Example 1.

### Experimental Example 1) SEM image

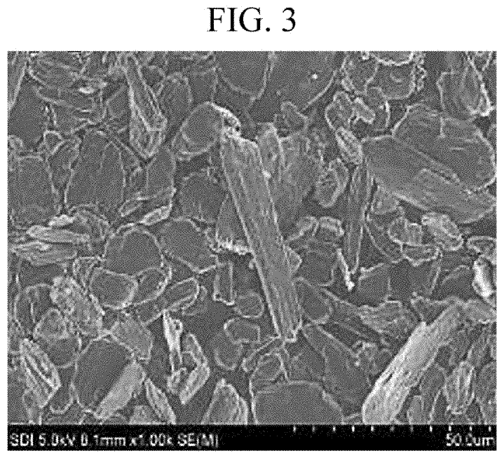

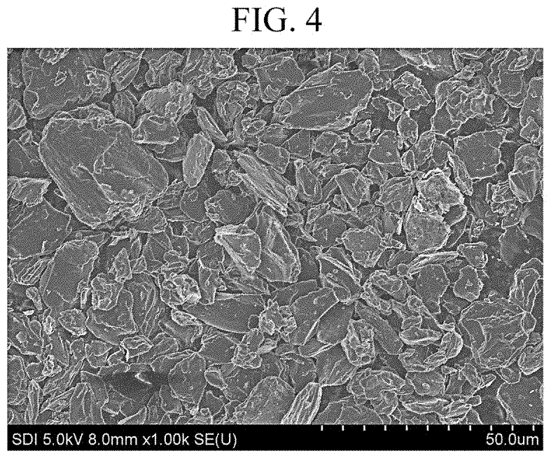

The SEM image for a surface of the negative active material layer of the negative electrode prepared in Example 1 is shown in FIG. 3. The SEM image for a surface of the negative active material layer of the negative electrode prepared in Comparative Example 1 is shown in FIG. 4.

From FIG. 3, it may be seen that the negative active material layer of Example 1 had the rod-shaped artificial graphite having a long length. This was clearly different from FIG. 4 showing the SEM image of the surface of the negative active material layer of the negative electrode according to Comparative Example 1 using two types of particle-shaped negative active materials.

### Experimental Example 2) Area % measurement

The area % in which the long rod-shaped artificial graphite as the first active material was occupied per unit area of the negative active material layer in the negative active material layer of Examples 1 to 4 was measured from particle analysis of the component constituents after capturing an image of 2D particles from an image of 3D particles using a particle analyzer (available from Malvern Panalytical, Ltd.). The results are shown in Table 1.

TABLE 1

| | Area (%) |
|---|---|
| Example 1 | 18 |
| Example 2 | 21 |
| Example 3 | 25 |
| Example 4 | 16 |

As shown in Table 1, the area in which the first active material was occupied in the negative active material layer according to Examples 1 to 4 was 16% to 25%.

### Experimental Example 3) Formation Capacity and Initial Efficiency Measurement

The half-cells according to Examples 1 to 4 and Comparative Examples 1 to 5 were formation charged and discharged at 1 C once, and then the formation charged and discharged cells were charged and discharged at 0.2C once. The formation charge capacities are shown in Table 2. The discharge capacity ratios to charge capacity during charging and discharging at 0.2C once, i.e., initial efficiency, were measured. The results are shown in Table 2.

### Experimental Example 4) High-Rate Characteristic Measurement

The half-cell according to Examples 1 to 4 and Comparative Examples 1 to 5 were charged and discharged at 0.2C once and charged and discharged at 3.0C once. The ratio of the discharge capacity at 3.0C to the discharge capacity at 0.2C was measured. The results are shown in Table 2 as discharge rate.

The half-cell according to Examples 1 to 4 and Comparative Examples 1 to 5 were charged and discharged at 0.2C once and charged and discharged at 2.0C once. The ratio of the discharge capacity at 2.0C to the discharge capacity at 0.2C was measured. The results are shown in Table 2 as charge rates.

TABLE 2

| | Formation | Initial | Discharge rate | Charge rate |
|---|---|---|---|---|
| | capacity | efficiency | (3.0 C/ | (2.0 C/ |
| | (mAh/g) | (%) | 0.2 C, %) | 0.2 C, %) |
| Example 1 | 347 | 90.7 | 98.3 | 44 |
| Example 2 | 348 | 90.5 | 98.0 | 45 |
| Example 3 | 348 | 91.0 | 97.8 | 43 |
| Example 4 | 349 | 91.4 | 99.1 | 46 |
| Comparative | 345 | 87.4 | 94.1 | 38 |
| Example 1 | | | | |
| Comparative | 344 | 88.1 | 94.6 | 39 |
| Example 2 | | | | |
| Comparative | 338 | 84.2 | 89.5 | 35 |
| Example 3 | | | | |
| Comparative | 336 | 83.8 | 88.7 | 33 |
| Example 4 | | | | |
| Comparative | 346 | 88.5 | 94.4 | 40 |
| Example 5 | | | | |

As shown in the Table 2, Examples 1 to 4, in which the rod-shaped crystalline carbon having a long diameter of about 80 μm to about 120 μm was used in an amount of 30 wt % based on 100 wt % of the negative active material, exhibited excellent formation capacity, initial efficiency, and high-rate charge and discharge rates.

Comparative Example 1, using two types of particle-shaped artificial graphite, exhibited deteriorated initial efficiency and high-rate charge and discharge rates.

Even if the particle-shaped artificial graphite second active material was used with the first active material having long length, Comparative Example 3 using carbon nanotubes or Comparative Example 4 using carbon nanofiber which corresponded to fiber-shaped, rather than rod-shaped, exhibited surprisingly deteriorated formation capacity, initial efficiency, and high-rate charge and discharge rates.

Furthermore, even though the long rod-shape with a long length was used, the use of the rod-shaped artificial graphite having a maximum long diameter of 70 μm as the first active material caused the significantly low initial efficiency and the deteriorated formation capacity and high-rate charge and discharge characteristics.

One or more embodiments may provide a negative active material for a rechargeable lithium battery exhibiting excellent high-rate and electrical conductivity characteristics.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A negative active material for a rechargeable lithium battery, the negative active material comprising:
about 8 wt % to about 50 wt % of a first active material; and
about 50 wt % to about 92 wt % of a second active material, all wt % being based on a total weight of the negative active material,
wherein the first active material includes a rod-shaped crystalline carbon having a maximum length of about 75 μm to about 160 μm.

2. The negative active material for a rechargeable lithium battery of claim 1, wherein the rod-shaped crystalline carbon has an aspect ratio of about 4 to about 30.

3. The negative active material for a rechargeable lithium battery of claim 1, wherein the rod-shaped crystalline carbon includes artificial graphite.

4. The negative active material for a rechargeable lithium battery of claim 1, wherein the second active material includes particle-shaped crystalline carbon, a rod-shaped crystalline carbon having a maximum length of less than about 75 μm, or a combination thereof.

5. The negative active material for a rechargeable lithium battery of claim 1, wherein the negative active material includes:
about 10 wt % to about 50 wt % of the first active material, and
about 50 wt % to about 90 wt % of the second active material.

6. A negative electrode for rechargeable lithium battery, the negative electrode comprising:
a current collector; and
a negative active material layer on the current collector, the negative active material layer including the negative active material of claim 1.

7. The negative electrode for rechargeable lithium battery of claim 6, wherein the first negative active material is present on about 9 area % to about 45 area % per unit area of the negative active material layer.

8. A rechargeable lithium battery, comprising:
the negative electrode of claim 6;
a positive electrode; and
an electrolyte.
